(19) United States
(12) Patent Application Publication
(10) Pub. No.: US 2016/0321647 A1
(43) Pub. Date: Nov. 3, 2016

(54) ELECTRONIC LOCKING DEVICES, SYSTEMS, AND METHODS

(71) Applicant: John McLaughlin, New York, NY (US)

(72) Inventor: John McLaughlin, New York, NY (US)

(21) Appl. No.: 15/139,437

(22) Filed: Apr. 27, 2016

Related U.S. Application Data
(60) Provisional application No. 62/153,867, filed on Apr. 28, 2015.

(51) Int. Cl. G06Q 20/32; G07C 9/00; H04M 1/725

(52) U.S. Cl. CPC G06Q 20/3278; G06Q 20/3224; H04M 1/72533; G07C 9/00309; G07C 2009/00769

(57) ABSTRACT

Methods and systems of unlocking a locked object are disclosed in which a mobile device receives a request for permission to unlock a locked object and relays the request for permission to a server. The server receives the request for permission and sends an electronic transmission to a lock such that the lock unlocks the locked object. The electronic transmission may contain a command to open the lock, or the server may generate a unique identifier and the electronic transmission contains the unique identifier. A lock coupled to the locked object receives and validates the unique identifier. When the unique identifier is validated the lock unlocks the locked object. Methods and systems may also include receiving a request from an individual to unlock a lock coupled to a locked object, processing payment information of the individual, and allowing the individual to unlock the lock. The payment information may be communicated via a mobile payment system.

### CROSS-REFERENCE TO RELATED APPLICATION

This application is a non-provisional of and claims priority to U.S. patent application Ser. No. 62/153,867, filed Apr. 28, 2015, which is hereby incorporated by reference in its entirety.

### FIELD OF THE DISCLOSURE

The following disclosure relates to systems and methods of unlocking a locked object. The disclosure further relates to systems and methods for facilitating one-time access to electronic locking devices in exchange for payment.

### BACKGROUND AND SUMMARY

Providing access to certain locations or areas that are restricted by locked doors in exchange for payment can generate substantial revenue. However, it is not always feasible to have people at these locations to collect payment and provide access. Accordingly, there is a need for an electronic system for receiving payment and providing access by electronically unlocking doors.

Disclosed embodiments alleviate these problems by providing systems and methods for electronically unlocking locked objects to provide access to a purchaser by receiving unlock requests and generating a unique identifier that the purchaser can enter into a lock so it unlocks. Disclosed systems and methods include locks that can receive and validate the purchaser's unique identifier and unlock upon validating the unique identifier. The request may include payment information and payment is processed before allowing the purchaser to unlock the lock.

Exemplary embodiments of an electronic locking system comprise a mobile device and a server. The mobile device receives from a user a request for permission to unlock a locked object and relays the request for permission. The server receives the request for permission and sends an electronic transmission to a lock such that the lock unlocks the locked object. The electronic transmission may contain a command to open the lock. In exemplary embodiments, the server receives the request for permission and generates a unique identifier to unlock the locked object. The electronic transmission to the lock may contain the unique identifier. The system may further comprise a lock coupled to the locked object. The lock receives and validates the unique identifier.

In exemplary embodiments, when the unique identifier is validated the lock unlocks the locked object. In exemplary embodiments, the unique identifier expires after a pre-set period of time. The unique identifier may be generated using one or more of date and time as inputs. In exemplary embodiments, the unique identifier is a personal identification number. In exemplary embodiments, the lock stores the unique identifier until it expires. In exemplary embodiments, the unique identifier comprises a plurality of unique identifiers and the lock stores each unique identifier until each expires. The plurality of unique identifiers expires after a pre-set period of time, and the lock stores each unique identifier until each expires.

Exemplary embodiments include a method of unlocking a locked object comprising receiving a request for permission to unlock a locked object, relaying the request for permission to a server, and generating at least one unique identifier to unlock the locked object. Exemplary methods further comprise providing a lock coupled to the locked object and validating the unique identifier. The request may be a request from an individual to unlock a lock coupled to the locked object.

The locked object may be unlocked when the unique identifier is validated. In exemplary embodiments, the unique identifier expires after a pre-set period of time. The unique identifier may be generated using one or more of date and time as inputs. In exemplary embodiments, the unique identifier is a personal identification number. The request may include payment information, and exemplary methods further comprise processing the payment information.

Exemplary methods of unlocking a locked object comprise receiving a request from an individual to unlock a lock coupled to a locked object, processing payment information of the individual, and allowing the individual to unlock the lock. The lock may have an internet connection or may not be connected to the internet, and the request may be communicated to the lock via Bluetooth. The request may include payment information communicated via a mobile payment system. In exemplary embodiments, the mobile payment system may be Apple Pay or Google Wallet.

These and other features and advantages will be appreciated from review of the following detailed description, along with the accompanying figures in which like reference numbers refer to like parts throughout.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a schematic diagram showing an exemplary system and method in accordance with the present disclosure;

FIG. 2 is a schematic diagram showing an exemplary system and method in accordance with the present disclosure;

FIG. 3 is a process flow diagram showing an exemplary system and method in accordance with the present disclosure;

FIG. 4 is a schematic diagram showing an exemplary system and method in accordance with the present disclosure;

FIG. 5 is a process flow diagram showing an exemplary system and method in accordance with the present disclosure;

FIG. 6 is a process flow diagram showing an exemplary system and method in accordance with the present disclosure;

FIG. 7 is a process flow diagram showing an exemplary system and method in accordance with the present disclosure;

FIG. 8 is a process flow diagram showing an exemplary system and method in accordance with the present disclosure'

FIG. 9 is a schematic diagram showing an exemplary system and method in accordance with the present disclosure; and

FIG. 10 is a process flow diagram showing an exemplary system and method in accordance with the present disclosure.

### DETAILED DESCRIPTION

In the following detailed description of embodiments of the disclosure, reference is made to the accompanying drawings in which like references indicate similar elements, and in which is shown by way of illustration specific embodiments in which disclosed systems and devices may be practiced. These embodiments are described in sufficient detail to enable those skilled in the art to practice the embodiments, and it is to be understood that other embodiments may be utilized and that logical, mechanical, functional, and other changes may be made without departing from the scope of the present disclosure. The following detailed description is, therefore, not to be taken in a limiting sense, and the scope of the present disclosure is defined only by the appended claims. As used in the present disclosure, the term “or” shall be understood to be defined as a logical disjunction and shall not indicate an exclusive disjunction.

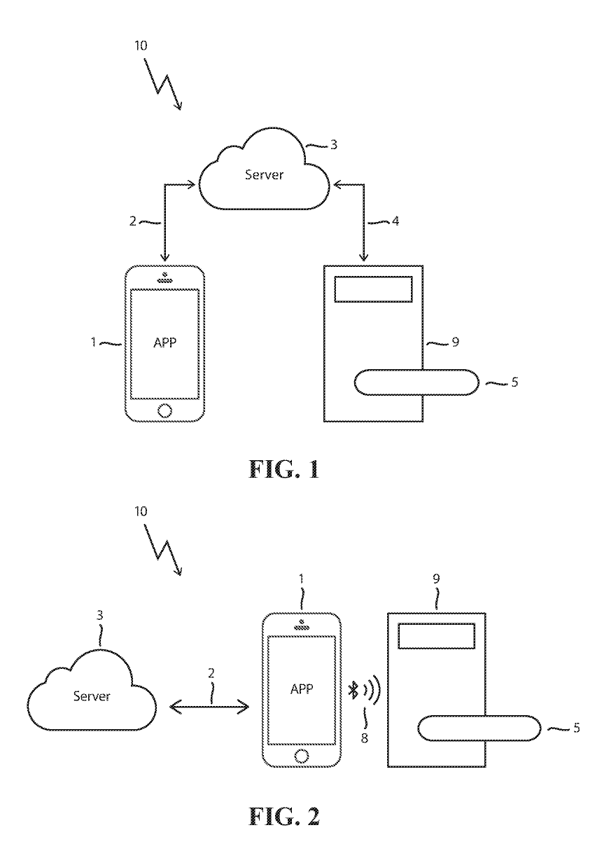

As shown in FIG. 1, exemplary embodiments of an electronic locking system 10 may have two user communication components—a mobile device 1 and a server 3—as well as a lock 5. The user downloads an application to his or her mobile device 1, which can, in various ways, provide the ability to open a lock 5 on a locked object 9. The user then selects a lock 5 via the mobile application, and, either a command is sent to the lock instructing it to open, a unique identifier is generated, or the user enters his or her payment details.

Via the application, the user enters into the mobile device 1 a request for permission to unlock a locked object. The mobile device 1 receives that request and the mobile application relays the request for permission 2 to the server 3. The server 3 receives the request for permission 2 and may send a command to the lock 5 via an electronic transmission 4 instructing the lock to open. Exemplary systems and methods may use the internet to allow the user to open the lock 5 via an application on his or her mobile device 1. In such embodiments, both the user's mobile device 1 and the lock 5 would have access to the internet.

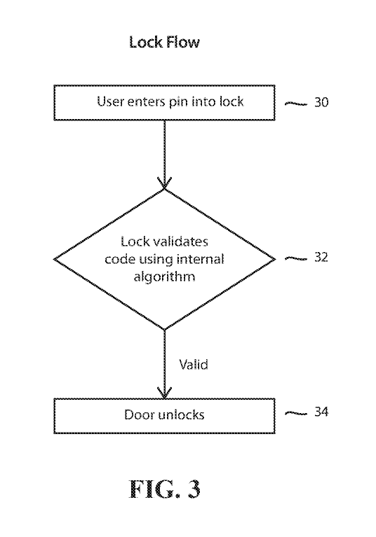

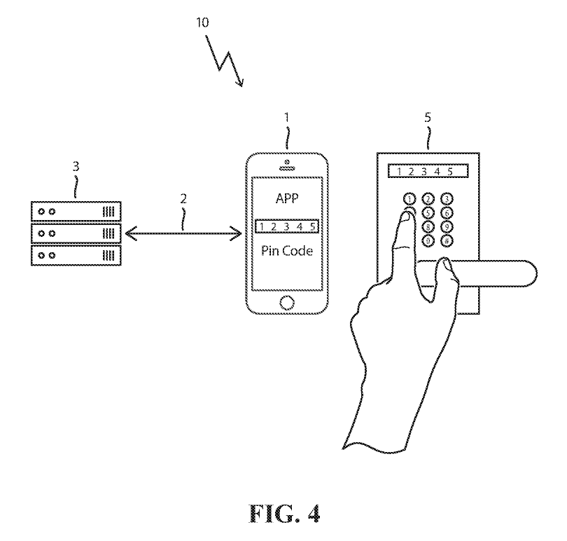

Turning to FIGS. 3 and 4, in exemplary embodiments the lock 5 may be operated by using a lock ID or unique identifier such as a personal identification number (PIN). In exemplary embodiments, when the server 3 receives the request for permission 2 the server 3 generates a unique identifier to unlock the object. The server then sends an electronic transmission 4 containing the unique identifier to the lock 5. The lock 5 receives and validates the unique identifier. When the unique identifier is validated the lock 5 unlocks the locked object 9.

The unique identifier may be comprised of any combination of letters, numbers, or symbols, or even biometric information. In exemplary embodiments, the unique identifier is a 5 or 6-digit one-time use PIN that expires after a pre-set period of time. The unique identifier could also be a reusable, multiple-use PIN specific to the user. In exemplary embodiments, the unique identifier is generated using date and/or time as inputs. The lock 5 may be configured to store the unique identifier until it expires. In exemplary embodiments, there are a plurality of unique identifiers and the lock 5 stores each unique identifier until it expires, which may be after a pre-set period of time. The lock 5 may be in communication with the mobile app and/or the server and receive the unique identifier information from the app and/or server.

In operation, the user can use the mobile app through mobile device 1 to request permission to unlock a locked object 9 such as a door. The app relays the permission request 2 to the server 3, which then processes payment and generates the PIN for the lock. In exemplary embodiments, the PIN is generated using an algorithm taking the lock ID, date, time and/or other information as inputs. The user enters the PIN into the lock (Step 30). Then the lock validates the PIN code is validated using an internal algorithm (Step 32), and the door or other locked object unlocks (Step 34). The PIN may remain valid for several hours before expiring.

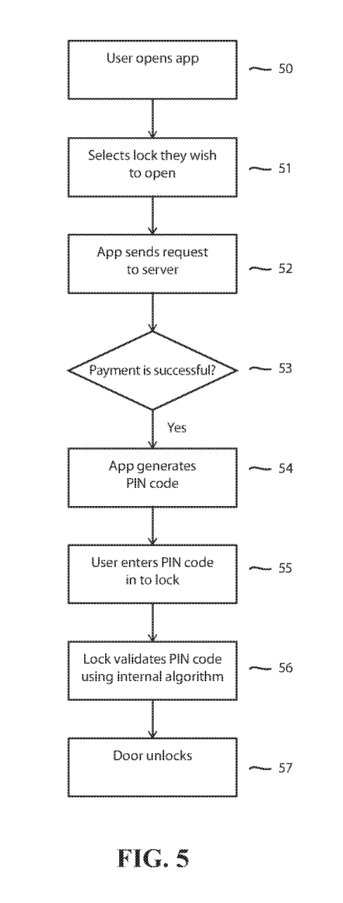

With reference to FIGS. 2 and 5, in exemplary embodiments the lock 5 could be completely standalone and communicate with either the mobile app or server 3 via Bluetooth. In exemplary embodiments, the permission request and/or the electronic transmission could be communicated via Bluetooth or any other communication technology 8 that does not require the internet. In embodiments in which the lock doesn't have the ability to communicate with the server, it may validate the PIN using its own similar internal algorithm, as shown in the secondary flow sequence of FIG. 5. The lock may store its lock ID, the date, and/or time as well as all previously used PINs until their expiry time has passed.

In operation, the user opens the app (Step 50), selects the lock he or she wants to open (Step 51), and the app sends the permission request to the server (Step 52). Optionally, the permission request may include payment information, and if payment is confirmed to be successful (Step 53), the app generates a PIN code (Step 54). Once the user enters the PIN in the lock (Step 55), the lock may use the algorithm to determine if the PIN is valid (Step 56) before unlocking the door (Step 57). Due to the nature of the algorithm, in exemplary embodiments a number of PINs can work at any one time. In exemplary embodiments, the number of valid/acceptable PINs is not more than 0.5% of the possible combinations. That makes it highly unlikely that a user could guess a PIN without purchasing.

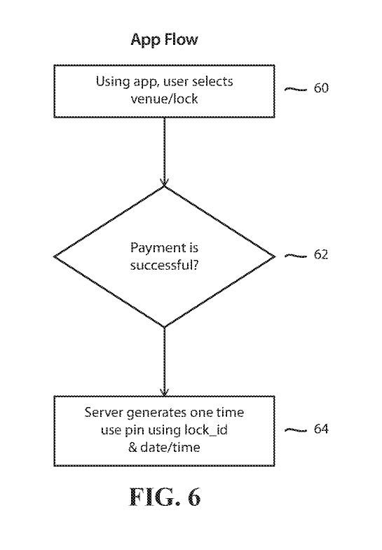

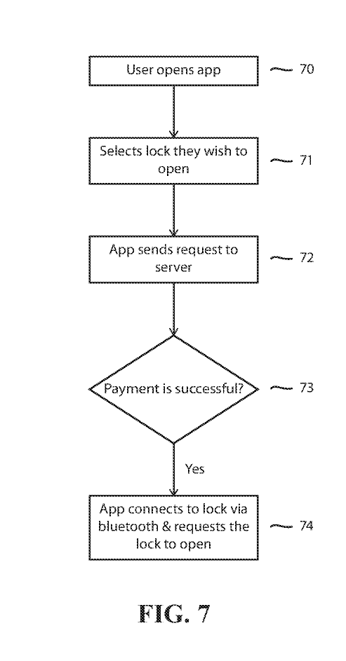

In exemplary embodiments shown in FIGS. 6 and 7, electronic locking systems and methods could employ payment details. The request for permission to unlock a locked object may include payment information. More particularly, as illustrated in the general app flow in FIG. 6 and a variation of the system flow in FIG. 7, after the user downloads and opens the app (Step 70) and selects a lock via the app (Step 60/Step 71), he or she can use previously entered payment details which have been stored in the app to open a locked object.

Alternatively, the user can enter his or her payment details if they are not already stored within the app, and the lock confirms the purchase. The app sends the request to the server (Step 72). The system then processes the payment information. Once the payment is successfully processed (Step 62/Step 73), the server generates a PIN (Step 64) and the application communicates via the internet with the lock, sending a request to the lock to open (Step 74), and allows the user to open the lock by selecting that option in the app. It should be noted that a PIN may or may not be required in systems and methods using payment.

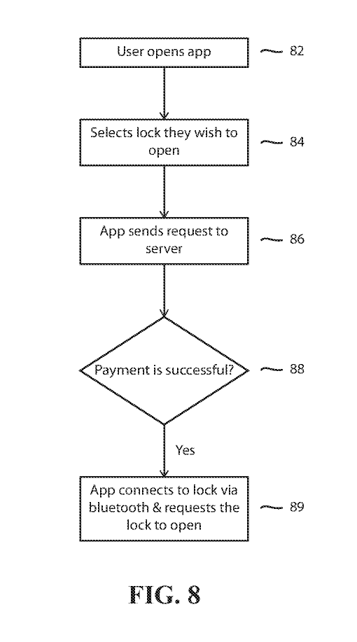

In exemplary embodiments, as shown in FIGS. 2 and 8, a user can access the lock via an app, even when the lock has no internet connection. This method requires that only the user have access to the internet on his or her mobile device. With reference to FIG. 8, the user downloads and opens an app (Step 82) in the same way as before. The user selects a lock via the app (Step 84), enters his or her payment details if they are not already stored within the app, and confirms the purchase. The permission request is then sent to the server (Step 86). Once payment is successfully processed (Step 88), the user has permission to open the lock. Since the lock itself is not connected to the internet, the user's device can communicate with the lock via Bluetooth to request the lock to open (Step 89).

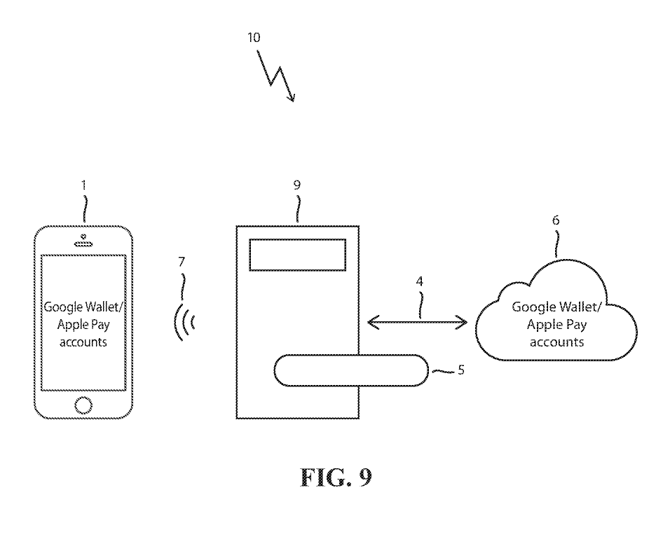

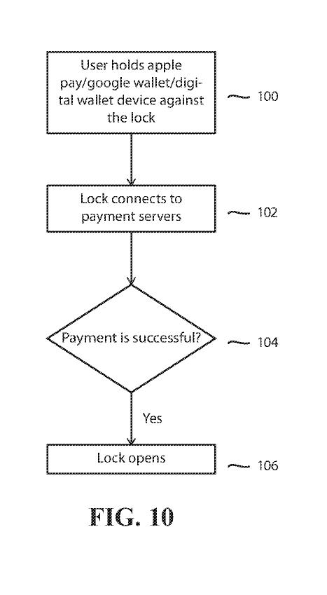

Turning to FIGS. 9 and 10, in exemplary embodiments, the request for permission to unlock a locked object may include payment information communicated via a mobile payment system. For example, exemplary systems and methods may use Apple Pay, Google Wallet, or other mobile payment technology 6 to process payment on the lock 5. The lock may be equipped with a near-field communication (NFC) antenna 7 that allows the user's device to communicate with it. The lock 5 is therefore able to read the user's payment details from the user's Google Wallet or Apple Pay accounts 6 and process payment, thereby opening the lock 5 on the locked object 9.

In order to communicate with the payment networks, the lock 5 may be connected to the internet. The user is not required to have an application on his or her phone for this method to work. In operation, the user holds the mobile device equipped with mobile payment technology against the lock (Step 100). Then the lock connects to the payment servers (Step 102), and if payment is confirmed to be successful (Step 104), the lock opens (Step 106).

Thus, it is seen that electronic unlocking systems and methods are provided. While the disclosed systems and methods have been described in terms of what are presently considered to be the most practical exemplary embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should be understood that any of the foregoing configurations and specialized components may be interchangeably used with any of the systems of the preceding embodiments. Although illustrative embodiments are described hereinabove, it will be evident to one skilled in the art that various changes and modifications may be made therein without departing from the disclosure. It is intended in the appended claims to cover all such changes and modifications that fall within the true spirit and scope of the disclosure.

What is claimed is:

1. An electronic locking system comprising:
a mobile device receiving a request for permission to unlock a locked object and relaying the request for permission; and
a server receiving the request for permission and sending an electronic transmission to a lock such that the lock unlocks the locked object.

2. The system of claim 1 further comprising a lock coupled to the locked object;
wherein the electronic transmission contains a command to open the lock.

3. The system of claim 1 further comprising a lock coupled to the locked object;
wherein the server generates at least one unique identifier and the electronic transmission contains the at least one unique identifier.

4. The system of claim 3 wherein when the lock receives and validates the unique identifier and unlocks the locked object.

5. The system of claim 3 wherein the unique identifier expires after a pre-set period of time.

6. The system of claim 3 wherein the unique identifier is generated using as inputs one or more of: date and time.

7. The system of claim 3 wherein the unique identifier is a personal identification number.

8. The system of claim 3 wherein the lock stores the unique identifier until it expires.

9. The system of claim 3 wherein the at least one unique identifier comprises a plurality of unique identifiers.

10. A method of unlocking a locked object, comprising:
receiving a request for permission to unlock a locked object;
relaying the request for permission to a server; and
sending an electronic transmission to a lock such that the lock unlocks the locked object.

11. The method of claim 10 further comprising:
providing a lock coupled to the locked object;
generating at least one unique identifier to unlock the locked object; and
validating the at least one unique identifier.

12. The method of claim 11 further comprising unlocking the locked object when the unique identifier is validated.

13. The method of claim 11 wherein the at least one unique identifier expires after a pre-set period of time.

14. The method of claim 11 wherein the unique identifier is generated using as inputs one or more of: date and time.

15. The method of claim 11 wherein the unique identifier is a personal identification number.

16. The method of claim 11 wherein the request is a request from an individual to unlock a lock coupled to the locked object.

17. The method of claim 10 wherein the request includes payment information and further comprising processing the payment information.

18. The method of claim 10 wherein the lock is not internet connected and the request is communicated to the lock via Bluetooth.

19. A method of unlocking a locked object, comprising:
receiving a request from an individual to unlock a lock coupled to a locked object, the request including payment information;
processing the payment information; and
allowing the individual to unlock the lock.

20. The method of claim 19 wherein the payment information is communicated via a mobile payment system.
